(19) United States
(12) Patent Application Publication
(10) Pub. No.: US 2015/0231931 A1
(43) Pub. Date: Aug. 20, 2015

(54) TREAD PROFILE OF A VEHICLE TIRE

(71) Applicant: Continental Reifen Deutschland GmbH, Hannover (DE)

(72) Inventor: Joerg Lehmann, Hannover (DE)

(21) Appl. No.: 14/704,577

(22) Filed: May 5, 2015

Related U.S. Application Data
(63) Continuation of application No. PCT/EP2013/068042, filed on Sep. 2, 2013.

(30) Foreign Application Priority Data
Nov. 5, 2012 (DE) 10 2012 110 567.7

(51) Int. Cl. B60C 11/12

(52) U.S. Cl. CPC B60C 11/124

(57) ABSTRACT

A tread profile for a vehicle tire includes a profile band running in an encircling manner over the circumference of the tread profile and a ripe having a first, a second and a third section. The first, second and third sections extend approximately axially and are straight lines in plan view. The first and third sections are arranged on a common imaginary straight line in plan view of the tread profile. The first and the third section having depth profiles deviating co-directionally from the radial direction. The second section has a depth profile deviating from the radial direction in the opposite direction. The second section, when the profile is new and viewed in plan, is arranged at an offset in the circumferential direction. The first and third sections conjointly define a first area. The second section defines a second area unequal to the first area.

### CROSS REFERENCE TO RELATED APPLICATIONS

This application is a continuation application of international patent application PCT/EP2013/068042, filed Sep. 2, 2013, designating the United States and claiming priority from German application 10 2012 110 567.7, filed Nov. 5, 2012, and the entire content of both applications is incorporated herein by reference.

### FIELD OF THE INVENTION

The invention relates to a tread profile of a vehicle tire, which tread profile has a profile band which runs in encircling fashion over the circumference of the tread and which has sipes, wherein the sipe is composed of at least three approximately axially running sections which are in the form of straight lines as seen in plan view, wherein the first and third sections form the two outer sections of the sipe and are arranged on a common imaginary straight line as seen in a plan view of the tread profile, and the first and third sections have depth profiles which deviate codirectionally from the radial direction by an angle α, and wherein the second section, in its depth profile, deviates from the radial direction by an angle β in the opposite direction to the first and third sections.

### BACKGROUND OF THE INVENTION

In the case of commercial vehicle tires, for example, sipes serve for breaking up the water film in the case of a wet roadway in order to obtain improved wet driving characteristics of the tread.

A tread profile is known from United States patent application publication 2005/0257870. A sipe of the tread profile is composed of three sections which, in the new state of the tire, are arranged on a common straight line. The two outer sections (the first and the third section) have identical depth profiles which deviate codirectionally from the radial direction. The middle section (the second section) has a depth profile oriented in the opposite direction to the two outer sections. The depth profiles of all three sections are coordinated with one another such that a stiffness balance is attained in the circumferential direction. The sipe has—as viewed in the cross section of the sipe—a depth profile formed from straight lines.

In the new state of the tire and thus of the tread profile, the profile elements that are divided up by the sipes are relatively tall and thus soft. The more worn, that is, shorter, the profile elements become, the stiffer they become. Therefore, in the new state of the tread profile, it is advantageous if the profile elements can adequately interlock by way of support effects in relation to opposite sipe walls, whereby the profile element is made stiffer.

### SUMMARY OF THE INVENTION

It is an object of the invention to provide a tread profile of a vehicle tire which, in the new state and over its service life, exhibits good handling and improved braking and drive characteristics.

The object is achieved in that the second section—in plan view of the tread profile and in the new state—is arranged offset in the circumferential direction, and in that the total size of the areas of the first and third sections is unequal to the size of the area of the second section.

According to the invention, a tread profile is provided which, in the new state, aside from the support effects in relation to opposite sipe walls in the circumferential direction, additionally exhibits support effects even under the action of lateral forces owing to the offset of the second section, leading to advantageous stiffening of the profile element both under the action of circumferential forces and under the action of lateral forces. The two ends of the second section are connected to the inner ends of the first and third sections, whereby two sipe sections oriented approximately in the circumferential direction are formed, the opposite sipe walls of which are supported against one another under the action of lateral forces.

In the depth profile, the sipe has a geometry which deviates from the new state. The first and third sections have depth profiles which are inclined codirectionally in one circumferential direction by the same angle, whereby two surfaces are formed which, over their depth profile, are inclined in one circumferential direction. The second section runs as an inclined surface deviating from the radial direction in the opposite circumferential direction. By virtue of the fact that the total size of the surfaces of the first and third sections is unequal to the size of the surface of the second section, different block stiffnesses in the circumferential direction and counter to the circumferential direction are attained. This is advantageous for optimally setting the tread profile for braking or coasting (one circumferential direction) and for driving (opposite circumferential direction), which require different stiffnesses for their optimum effect. All of the sections preferably end—regardless of their profile—at the same radial depth.

A tread profile with a so-called “3D sipe” is created which exhibits good handling in the new state and over its service life and which has improved braking and drive characteristics.

“Axial direction” refers to the direction along the tire axis.

“Circumferential direction” refers to the direction along tire or tread rolling direction.

“Radial direction” refers to the direction from the tire central point to the tread.

“Width of the sipe” refers to the minimum extent of a sipe in the circumferential direction.

It is practical if the offset of the second section in the circumferential direction—as seen in plan view and in the new state of the tread profile—amounts to between 2 mm and 10 mm measured perpendicular to the imaginary straight line on which the first and third sections are situated. This results in mechanical support in the presence of a large profile depth (new tire), which mechanical support reduces with wear that occurs over the service life. The fundamental disadvantage of the lower stiffness in the presence of the high profile depth of the new tire is thus counteracted.

It is advantageous if the first and third sections and the second section enclose an angle α and an angle β of between 5° and 25° with the radial direction, wherein the angle α is equal to or unequal to the angle β. Depending on the field of use, angles may be selected which generate optimum, and possibly different, stiffnesses for braking and driving.

A tread profile of this type is intended for use in a vehicle tire, preferably in a drive axle tire of a commercial vehicle tire.

### BRIEF DESCRIPTION OF THE DRAWINGS

The invention will now be described with reference to the drawings wherein:

FIG. 1 is a three-dimensional view of a tread profile of a vehicle tire having sipes in the profile elements;

FIG. 2 is a three-dimensional view of a sipe;

FIG. 3A is a plan view of the sipe from FIG. 2 in the new state;

FIG. 3B is a plan view of the sipe from FIG. 2 in the approximately 50% worn state; and,

FIG. 3C is a plan view of the sipe from FIG. 2 in the approximately 100% worn state.

### DESCRIPTION OF THE PREFERRED EMBODIMENTS OF THE INVENTION

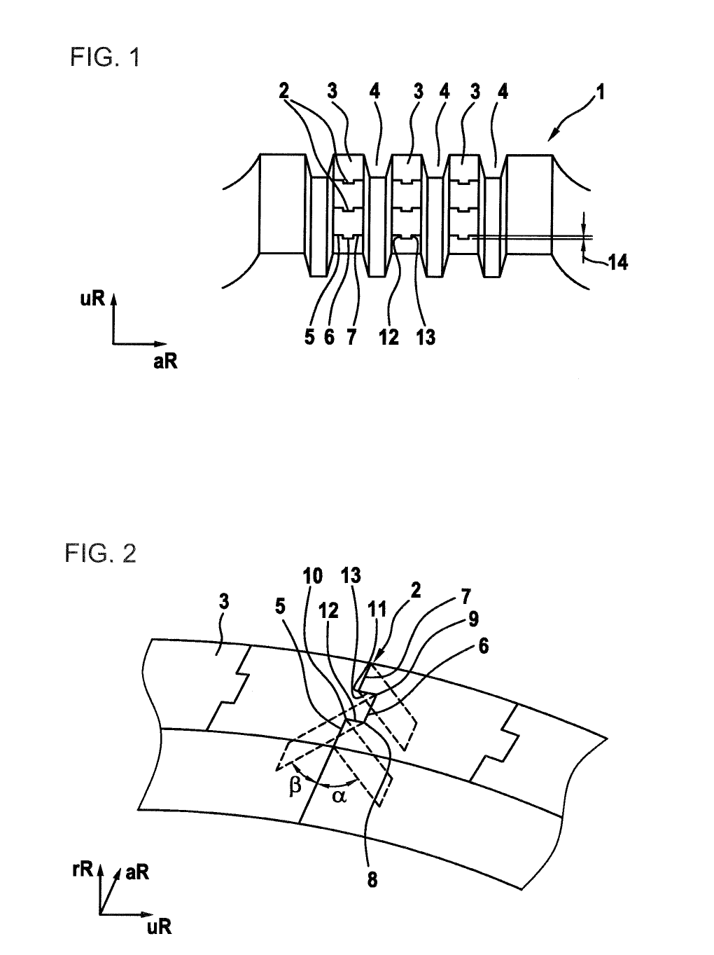

FIG. 1 shows a three-dimensional view of a tread profile 1 of a vehicle tire with sipes 2 in the profile elements, in this case profile bands 3. Each profile band 3 is delimited on both sides by circumferential channels 4. The sipe 2 extends all the way through the profile band 3 in the axial direction aR. The sipe 2 is made of three sections (5, 6, 7). The first section 5 and the third section 7 form the two outer sections of the sipe 2 and are arranged approximately in the axial direction aR on a common imaginary straight line. In a plan view of the tread profile, the second section 6 likewise forms a straight line, and in the new state, has an offset 14 of 8 mm, measured in the circumferential direction and counter to the tire direction of rotation, in relation to the first section 5 and the second section 6.

FIG. 2 shows a three-dimensional view of a sipe 2 from FIG. 1. In the depth profile, the planar surfaces of the first section 5 and of the third section 7 each enclose an angle α of 10° with the radial direction β, whereas the surface of the second section 6 encloses a value β of 8° with the radial direction rR, and is inclined in the opposite direction in relation to the surfaces of the first and third sections (5, 7). The total size of the surfaces of the first and third sections (5, 7) is unequal to the size of the surface of the second section 6. The two ends (8, 9) of the second section 6 are connected to the inner ends of the first and third sections (10, 11), whereby two sipe sections (12, 13) oriented approximately in the circumferential direction are formed. All three sections (5, 6, 7) have the same length. All three sections (5, 6, 7) are arranged so as to form a continuous sipe 2 without breaks or interruptions.

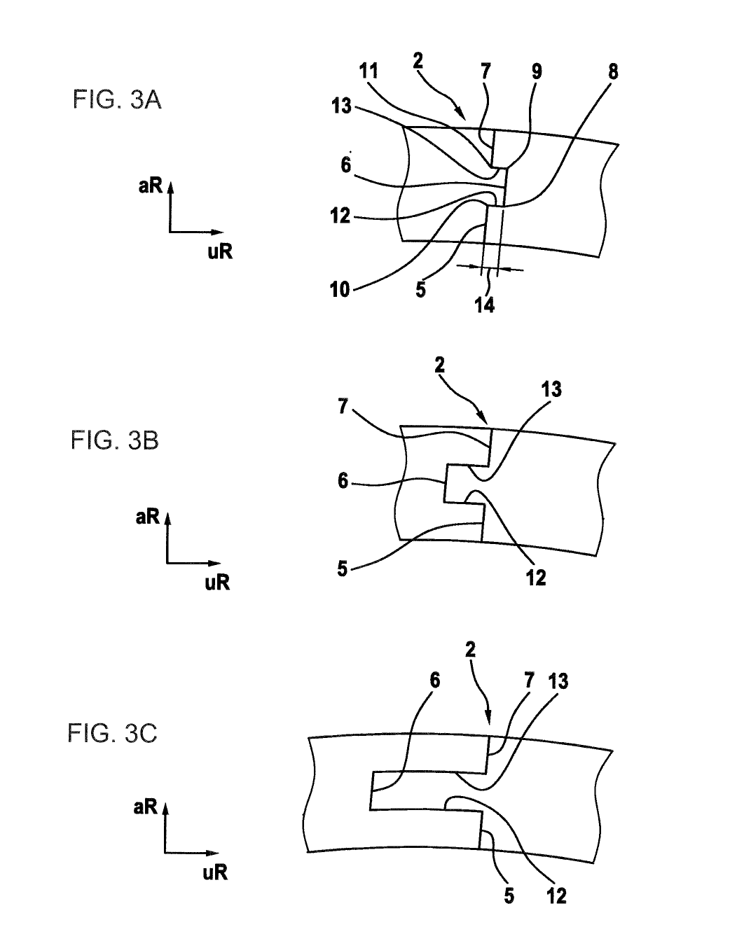

FIG. 3A shows a plan view of the sipe 2 from FIG. 2 in the new state, whereas FIG. 3B shows the same plan view in the approximately 50% worn state and FIG. 3C shows the same plan view in the approximately 100% worn state. It can be seen that the sipe sections (12, 13) oriented approximately in the circumferential direction uR increase in length with progressively increasing wear.

It is understood that the foregoing description is that of the preferred embodiments of the invention and that various changes and modifications may be made thereto without departing from the spirit and scope of the invention as defined in the appended claims.

### LIST OF REFERENCE DESIGNATIONS

### (Part of the Description)

1 Tread profile

2 Sipe

3 Profile band

4 Circumferential channel

5 First section

6 Second section

7 Third section

8 End of the second section

9 End of the second section

10 Inner end of the first section

11 Inner end of the third section

12 Sipe section

13 Sipe section

14 Offset

rR Radial direction

aR Axial direction

uR Circumferential direction

What is claimed is:

1. A tread profile for a vehicle tire, the tread profile defining a circumference, a circumferential direction and a radial direction, the tread profile comprising:
a profile band running in an encircling manner over the circumference of the tread profile;
a sipe having at least a first, a second and a third section;
said first, second and third section extending approximately axially and being configured as straight lines when viewed from above;
said first section and said third section forming the two outer end sections of said sipe and being arranged on a common imaginary straight line when the tread profile is viewed in plan;
said first section and said third section each having depth profiles deviating co-directionally from the radial direction (rR) at an angle α;
said second section having a depth profile deviating from the radial direction (rR) by an angle β in a direction opposite to said first and said third sections;
said second section, when the tread profile is viewed in plan and in a new state thereof, being arranged at an offset with respect to the circumferential direction (uR);
said first and said third section conjointly defining a first area; and,
said second section defining a second area which is unequal to said first area.

2. The tread profile of claim 1, wherein said offset in the circumferential direction, when the tread profile is viewed in plan and in said new state, is between 2 mm and 10 mm measured perpendicularly to said imaginary straight line.

3. The tread profile of claim 1, wherein:
said angles α and said angle β lie between 5° and 25°; and, said angles α are equal or unequal to said angle β.

4. A pneumatic vehicle tire comprising:
a tread profile having a profile band and a sipe;
said tread profile defining a circumference, a circumferential direction and a radial direction;
said profile band running in an encircling manner over the circumference of the tread profile;
said sipe having at least a first, a second and a third section;
said first, second and third section extending approximately axially and being configured as straight lines when viewed from above;
said first section and said third section forming the two outer end sections of said sipe and being arranged on a common imaginary straight line when the tread profile is viewed in plan;
said first section and said third section each having depth profiles deviating co-directionally from the radial direction (rR) at an angle α;
said second section having a depth profile deviating from the radial direction (rR) by an angle β in a direction opposite to said first and said third sections;
said second section, when the tread profile is viewed in plan and in a new state thereof, being arranged at an offset with respect to the circumferential direction (uR);
said first and said third section conjointly defining a first area; and,
said second section defining a second area which is unequal to said first area.

5. The pneumatic vehicle tire of claim 4, wherein the pneumatic vehicle tire is a drive axle tire of a commercial vehicle.

6. The pneumatic vehicle tire of claim 4, wherein said offset in the circumferential direction, when the tread profile is viewed in plan and in said new state, is between 2 mm and 10 mm measured perpendicularly to said imaginary straight line.

7. The pneumatic vehicle tire of claim 4, wherein:
said angles α and said angle β lie between 5° and 25°; and, said angles α are equal or unequal to said angle β.
